(19) United States
(12) Patent Application Publication
(10) Pub. No.: US 2005/0034978 A1
(43) Pub. Date: Feb. 17, 2005

(54) Electrolytic cell stack with porous surface active electrode for removal of organic contaminants from water and method to purify contaminated water

(76) Inventors: Abdullah Kazi, San Jose, CA (US); Roy L. Hays, San Jose, CA (US)

Correspondence Address: CARR & FERRELL LLP, 2200 GENG ROAD, PALO ALTO, CA, 94303, US

(21) Appl. No.: 10/638,856

(22) Filed: Aug. 11, 2003

(51) Int. Cl. C02F 1/46

(52) U.S. Cl. 204/267

(57) ABSTRACT

A wet oxidation/reduction electrolytic cell stack, system, and method for the remediation of contaminated water is disclosed. A porous electrode of large surface area produces powerful oxidizing agents in situ without having to add any reagents, oxidizers, or catalysts to the water to be treated. Further, by the appropriate selection of electrode material, organic contaminants may be absorbed onto the surface of the electrode and subsequently oxidized to provide a dynamically renewable porous electrode surface. Flow rates, and power requirements may be tailored to the specific moieties to be removed, thus allowing local treatment of specific waste streams resulting in direct discharge to a publicly owned treatment works (POTW) or surface water discharge. A novel feature of this invention is the ability to remove both organic and metal contaminants without the addition of treatment reagents or catalysts.

### FIELD

This invention is directed to an apparatus and method for the remediation of contaminated water, and more particularly to a stack of electrolytic oxidation-reduction cells for the continuous remediation of water, in particular the treatment of organic and inorganic contaminants in contaminated groundwater, surface water, and wastewater, and continuous processes therefore.

### BACKGROUND

Environmental laws and their resulting regulations are placing an increased emphasis on the water quality of both surface waters and ground water. Previously acceptable methods for disposing of contaminated water are now either no longer allowed or subject to strict permit requirements. Discharges of industrial wastewater, for example, must meet stringent discharge concentration limits for heavy metals such as copper, lead, nickel, mercury, cadmium, chromium VI, zinc, and silver. Other controlled pollutants include chlorofluorocarbons, pesticides, and halides. Municipalities now generally require a manufacturer to obtain a discharge permit prior to the manufacturer being allowed to discharge its wastewater to a publicly owned treatment works (POTW). The permit generally places upper limits on the concentrations of the various pollutants, prohibiting discharges where the concentration of any individual critical contaminant exceeds the permitted level.

These discharge limits are ultimately defined by the water quality standards set forth by the federal government and are based on the use intended for the body of water; e.g., recreation, swimming, fishing, and drinking. Discharges from the POTW must conform to the federal standards. Consequently, industrial discharges to the POTW must not be so contaminated as to exceed the ability of the POTW to either treat the waste, reduce the concentration by dilution, or to pose a threat to the biology of the POTW. Likewise, any industry discharging directly to a stream, river, groundwater that eventually finds its way to a navigable body of water is also subject to the stringent federal clean water standards.

In an effort to meet either the POTW discharge permit requirements or the federal National Pollution Discharge Elimination System (NPDES) standards for discharge to surface bodies of water, many industrial companies pre-treat their industrial wastewater prior to discharge. Generally, the waste water from all operations are piped to a end-of-pipe treatment facility wherein the pH of the combined waste water is adjusted to favor precipitation of sulfite and hydroxide salts as sodium bisulfite and/or lime is introduced to the combined waste. This pre-treatment method is inadequate for a number of reasons including: 1) more stringent discharge requirements demand concentration levels that are less than the equilibrium level of the dissolved metal using the foregoing treatment chemistries; 2) “fines” or small particles of precipitate may pass through the pre-treatment system and into the environment; 3) the mix of various metals and other contaminants make any single type of treatment a compromise, at best, because each metal has its own optimum pH and chemistries for precipitation (i.e., different metal-hydroxide solubility curves); and 4) the raw materials cost of the sodium bisulfite and lime can be very high, particularly where flow rates of waste water are high. Further, pre-treatment processes are batch processes wherein a sufficient amount of wastewater is first accumulated. When a sufficient quantity of wastewater has been accumulated, the precipitants are added. The batch nature of this pre-treatment process requires that large holding tanks be provided to collect the waste water, a possible back-up tank in the event the primary holding tank requires repair, and secondary containment for both tanks, because under current environmental law, spillage of industrial waste water is prohibited as an unpermitted release of a hazardous waste to the environment.

Aqueous organic streams must be remediated as well. Because pesticides and chlorofluorocarbons (CFC's) might otherwise kill the microorganisms associated with a biological treatment operation, the pesticides and CFC's must be concentrated, for example by steam distillation, with the distillate being hauled away for incineration. Other organic contaminants may be bio-remediated. The final effluent may be passed through an activated carbon column for “polishing” the pre-treated waste water thus rendering the polished waste water suitable for reuse for certain uses at the industrial site. However, the cost of periodic renewing or recharging, and eventually replacing the activated carbon, makes this operation economically less desirable than to merely discharge the pre-treated water and to purchase or manufacture “new” deionized water.

In addition to the large capital cost outlay of installing a pre-treatment facility, as well as the staffing, maintenance and operational costs associated with running the facility, there are regulatory requirements requiring a permit to operate the facility and requirements for monitoring the performance of the facility.

In many instances, clean water standards, particularly those associated with contaminated groundwater, are technology based. In other words, should a hazardous waste spill result in contamination of an underlying aquifer, remediation of the contaminated groundwater will be required until the specific contaminants are “undetectable”. However, with the continuing advances made in quantitative chemical measurement instruments, the non-detectable limits are now being pushed from the parts per million range to a fraction of a part per billion. Consequently, remediation of a contaminated groundwater site that might have previously involved removal of just a few thousand gallons of water for incineration or other hazardous waste disposal, would now require removal and disposal of many millions of gallons of water. Removal and disposal of this quantity of water would be extremely cost prohibitive. Unfortunately, however, presently available technologies that enable the treatment of contaminated groundwater to achieve a level of cleanliness that will permit reinjection of the treated groundwater into the aquifer require multistage separation operations, require the removal and disposal of the separated hazardous waste, and costs many millions of dollars. What is needed is a single pass, low cost technology that will achieve the clean water standards to permit reinjection of treated groundwater back into the aquifer without having to dispose of the remediated contaminant.

A process for the direct catalytic oxidation of hydrocarbons is taught by Sen et al., U.S. Pat. No. 5,393,922. They teach the use of an externally supplied oxidizing agent, such as hydrogen peroxide, in the presence of a metallic or metal salt catalysts. In this case, an external supply of hydrogen peroxide, an extremely caustic compound, must be made available in order to perform the process. Further, the process is taught for the remediation of light organic compounds, and not for inorganic compounds and metals.

Soresen et al. teach a method for treating polluted material such as industrial waste water involving a wet oxidation process by using an externally supplied oxidizing agent such as potassium permanganate, hydrogen peroxide, a peroxodisulphate, a hypochlorite, and the like. Also, they teach a batch process, thus significantly limiting the throughput of the process and requiring large holding tanks and large reactor.

A wastewater treatment process is described by Ishii et al., U.S. Pat. No. 5,399,541, whereby organic compounds are decomposed using a two component catalyst, the first component being iron oxide and the second component being selected from a noble metal. The described process, however, requires an oxygen gas source to supply oxygen at between 1 to 1.5 the required stoichiometric amounts for complete oxidation of the organic contaminants, as well as raising the temperature of the wastewater to between 100 degrees and 370 degree Celsius at a pressure sufficient to prevent boiling of the wastewater. These process conditions would necessarily entail a batch-type operation, and a complex insulated reactor and boiler system. The capital costs, and operating expense of maintaining such a system would necessarily exceed that of more conventional organic treatment systems (such as rotating biological contactors or RBCs), and would pose additional hazards due to the temperatures and pressures involved.

Drawbacks of the above prior art were addressed in Kazi, et al., U.S. Pat. No. 6,270,650 B1, which is herein incorporated by reference. Instead of employing chemical means for remediating water, the described apparatus comprises a porous electrode. When direct current is applied, oxidizing and reducing agents are produced in situ. While an improvement over the prior art, the apparatus suffers from several drawbacks. First, it does not have a sufficient ratio of surface area to volume of flow. This results in having to recirculate contaminated water additional times through the apparatus before it can be discharged to a POTW. Second, the apparatus is power intensive, requiring large amounts of electrical current. Third, the apparatus was designed to use only direct current.

Accordingly, there is an escalating need for a water remediation apparatus and method that are not subject to the limitations and potential safety hazards associated with the background art; that do not require the use of additional precipitants, oxidizers, and catalysts, the use of which results in an increase the total dissolved solids (TDS) of the pre-treated effluent, or other externally supplied reagents; one that can be moved “up the pipe” prior to combining treatment incompatible waste water streams, and onto the manufacturing floor where waste water streams are segregated, and attached to process equipment for local waste water treatment to permit direct discharge from the process to the POTW without the need for pretreatment (or pretreatment permit); and one that can be fine tuned to the contaminants of interest to better able meet increasingly stringent discharge requirements. In addition, there is a need to improve the flow rate of contaminated water, to reduce the level of electrical power consumption, and to permit the use of both direct and alternating current.

### THE INVENTION

### Objects

Accordingly, it is an object of this invention to provide a system and method for remediating water by electrolytic oxidation/reduction of both organic and inorganic contaminants that overcomes the limitations of the background art, and permits remediation without the need for externally supplied reagents, catalysts, or oxidizing agents, and without the need for exotic or dangerous process conditions.

It is another object of this invention to provide a system and method where the working surfaces of the stack of electrolytic cells of this invention have dynamically renewable electrode surfaces, thus avoiding dispensable system components. It is another object of this invention to provide a stack of electrolytic wet oxidation cells that can be ganged depending to achieve either higher volumetric capacity, or enhanced remediation.

It is another object of this invention to provide a water remediation system producing no hazardous waste residues and whereby the remediation products are either out gassed or are collected as dissolved mineral salts.

It is another object of this invention to provide a water remediation device capable of being attached directly to a manufacturing process to permit localized pollution prevention by being adaptable to the specific contaminant to be removed resulting in enhanced remediation efficiency as compared to end of pipe treatment methods and processes of the background art.

Still other objects will be evident from the specification, claims and drawings of this application.

### SUMMARY

The present invention is directed to a novel stack of electrolytic cells for the electrolytic, wet-oxidation/reduction of contaminants in contaminated groundwater, industrial wastewater, contaminated surface waters, and spent process water. The stack of electrolytic cells comprises reaction chambers each containing a porous, electrically conductive electrode; a second electrode which may be either porous or non-porous; and a porous insulator sleeve or membrane separating the porous electrode from the second electrode; and an inlet port for introduction of the contaminated water to the electrolytic cells.

Where removal of metals is desired, the porous electrode is negatively charged with respect to the second electrode, thus reducing the metals from the water. Where organic contaminants are to be removed, the porous electrode is positively charged with respect to the second electrode, thus oxidizing the organic contaminants. If both electrodes are porous or alternating current is used, both metals and organic contaminants may be removed from the water simultaneously.

By way of operation, and assuming for this explanation that remediation is directed at organic contaminants, organically contaminated water is introduced to a positively charged, porous anode by way of a distributed flow inlet system. The inlet system distributes the flow over the anode to minimize any channeling of the contaminated water through the anode. Alternately, where the pressure drop through the anode is sufficiently high, the inlet may simply be an inlet tube opening over a sufficient headspace above the anode to permit an even water pressure distribution across the entire headspace area of the anode.

Channeling is prevented by ensuring that the porous electrode fills the region both between the two electrodes and between the electrodes and the interior surface of the reaction chamber wall. This ensures that contaminated water does not find a channel around the porous electrode, but rather flows through the porous electrode.

The porous electrode may be of any porous, conducting material, but preferably one that has a high surface area and a large number of reactive sites to catalyze the various reactions occurring on or near the surface of the material of the porous electrode, such materials including activated carbon; metal plated activated carbon, the metals including, but not limited to silver, gold, ruthenium, rhodium, and platinum; sintered metal powders; sintered conductive plastics; metal mesh; and conductive, open-cell sponges. The highly conductive surface, and high surface area of the porous electrode results in a low current density, thus preventing formation of hot spots and ensuring minimum polarization of the electrode.

The second electrode is wrapped around and insulated from the porous electrode by a porous insulating sleeve or membrane. The sleeve may be any non-conductive, porous material, including but not limited to foraminous plastic membranes; plastic or fabric screens and meshes, and the like, to form a porous, insulating sleeve around the second electrode.

Again, assuming organic compounds as the contaminant, the contaminated water flows through the porous electrode and the organic contaminants are oxidized to carbon dioxide, nitrates, and sulfates depending on whether the contaminant molecules contain carbons, nitrogen, or sulfurs. The carbon dioxide is removed as a dissolved gas in the treated water, or is out gassed through the outlet port.

A novel feature of this invention is that, unlike the processes of the background art, external reactants, oxidizers, and catalysts are not required. All of the oxidizing and reducing agents used to remediate the contaminants are generated from the water being remediated within the cell. It is well known that water exists in a partially ionized state as H⁺, and OH⁻, in equilibrium at a neutral pH, according to the equation:
H₂O.revreaction.H⁺(10⁻⁷ M)+OH⁻(10⁻⁷ M) (1)

Consequently, the anode, or positively charged electrode, will tend to become slightly polarized with the hydroxyl ion. Similarly, the cathode, or negatively charged electrode, will tend to become slightly polarized with the hydrogen ion.

We have discovered that with the application of an applied voltage, oxidation and reduction may take place via the free radical intermediates formed during the electrolysis of water to generate hydrogen and oxygen molecules. We have also discovered that the presence of the porous, high surface area, high conductivity, electrode, appears to catalyze and prolong the life of the free radicals and permit the oxidation and reduction reactions to occur on the porous electrode surface. The electrolysis half reactions and their standard oxidation potentials are shown below in Equations 1 and 2.
2H₂O+2e⁻.revreaction.H₂(g)+2OH⁻(10⁻⁷ M) E=−0.8277V (2)
2H₂O.revreaction.O₂(g)+4H⁺+4e⁻(10⁻⁷M) E=+1.229V (3)

Equation 2 describes the reaction occurring at the cathode where with voltages lower or less than −0.8277 volts, the hydrogen is stripped from the water molecule and reduced to hydrogen gas. The hydrogen free radical is formed by the intermediate steps:
2H₂O+2e⁻.revreaction.2H+2OH⁻.revreaction.H₂+2OH⁻ (4)

The formation of the hydrogen molecule requires formation of the atomic hydrogen intermediate, H., prior to formation of the dimer. We have discovered that where voltages are less than −0.8277 volts, or where an electrically conductive catalyst surface comprises the cathode thus facilitating the formation of the atomic hydrogen, the formation of atomic hydrogen is available to act as a reducing agent by giving up the free electron to form H⁺ and, thereby, reducing metal onto the conductive surface Accordingly, using a high surface area, porous electrode as the cathode is preferred when heavy metals are the contaminants of interest. Further, when the wastewater is slightly basic, the creation of H⁺ resulting from the reduction reactions between the metal ion and H. occurring at the surface of the catalyst, tends to neutralize the pH of the treated water.

Additionally, at higher, or more positive, voltages, metals may be plated out directly onto the cathode without the hydrogen radical, and resulting hydrogen gas. For example, Table I lists the metals principally found in industrial waste water discharges and are the metals normally listed as critical contaminants and subject to concentration limits pursuant to a discharge permit. As can be clearly seen, all of the standard oxidation potentials are greater than −0.8277 volts, thus permitting the plating out of the metal at the cathode at voltages not yet negative enough to commence the reduction of hydrogen gas from water. Accordingly, when using the porous electrode as the cathode, the extremely high surface area and low current density results in the following metal contaminants being plated out onto the porous cathode substrate.

TABLE I
Standard Oxidation Potential In a Basic Solution

| | Standard |
|---|---|
| | Oxidation |
| Metal | Potential |
| Silver | +0.7996 |
| Cadmium | −0.4024 |
| Mercury | +0.852 |
| Nickel | −0.23 |
| Copper | +0.3460 |
| Lead | −0.1263 |
| Zinc | −0.7628 |
| Chromium III | −0.74 |

The above-described configuration of using the porous electrode as the cathode immediately suggests an electrolytic wet reduction cell and process incorporated into any process employing heavy metal baths. For example, the preparation of sputtered aluminum substrates for the manufacture of computer direct access storage devices (i.e., magnetic memory disks) requires that the aluminum substrate be first-plated with a nickel phosphate compound. Rather than shipping a spent bath to a hazardous waste disposal site or sending it down the drain to an end-of-pipe pretreatment facility, the electrolytic cell stack of this invention may be attached to the bath to remove metal contaminants in the bath (other than the nickel) thus prolonging the life of the bath. Alternately, the electrolytic cell stack of this invention may be used to plate out the nickel from the spent bath onto the porous cathode. Once plated out, the water may be in a condition for direct discharge to the sanitary sewer drain without the need for pretreatment. The nickel may be removed by reversing the polarity on the porous electrode (i.e., oxidizing the plated metal) while passing a slightly acidic solution through the electrolytic cell stack of this invention. The recovered nickel may then be reused, reclaimed, or sold. Similarly, the electrolytic cell stack of this invention may be used on copper plating lines such as those found in the printed circuit board industry and the semiconductor manufacturing industry, and in photolabs for the recovery of silver.

In a similar fashion, water is oxidized at the anode according to Equation 3. Consequently, where the voltage at the anode exceeds +1.229 volts, oxygen gas is produced. Alternately, the formation of the oxygen free radical is facilitated by a catalyst such as the reactive sites on the porous electrode, electrically connected to now perform as the anode. As in the above offered explanation for the reduction of the metal contaminants, the following proposed mechanism is presented by way of theory and not as a limitation to the scope of the claims of this invention. It is thought that the chemical contaminants, in this case organic contaminants, are adsorbed onto the highly conductive, catalytic surface of the porous anode. When a predetermined voltage is applied to the porous anode, the hydroxyl free radical and atomic oxygen is formed in situ on the surface of the porous anode and immediately reacts with the adsorbed organic contaminant to produce an oxidation product. During oxidation, oxygen gas is evolved via the hydroxyl free radical and atomic oxygen intermediates according to the equation:
2OH⁻.fwdarw.2HO.+2e⁻.revreaction.H₂O+O.revreaction.½O₂ (5)
Both the hydroxyl radical and the atomic oxygen are powerful oxidizing agents.

We have discovered that the formation of the hydroxyl radical and atomic oxygen on the surface of the porous electrode continually oxidizes any organic matter adsorbed on the high surface area electrode into either low molecular weight, non-hazardous organic compounds such as low carbon number alcohols, ketones, esters, and the like, or to carbon dioxide which is removed by either dissolution in the water or vented off as a gas.

A novel feature of our invention, mentioned above, is that the powerful hydroxyl radical and atomic oxygen moieties are generated in-situ; i.e., no external oxidizing or catalyzing reagent is required to remove the organic contaminants. Further, because the porous anode may be used to catalyze the generation of the hydroxide radical, and atomic oxygen, the action of these powerful oxidizing agents at the electrode surface dynamically renews the surface of the electrode, tending to keep the electrode surface from becoming blinded by over adsorption of organic contaminants. The value of this feature becomes readily apparent when one realizes the economics associated with never having to change-out or recharge an activated charcoal column. The charcoal, being conductive, may be used in the electrolytic cell of this invention as the high surface area, porous anode (or cathode). As organic contaminants are adsorbed into the carbon, the contaminants are oxidized. Consequently, the carbon resists becoming loaded, and seldom needs to be recharged or changed out.

Current technology requires surface active carbon to be disposed of when it becomes loaded with contaminants. This invention permits the regeneration and/or restoration of adsorption capacity back on loaded surface active carbon or other surface active particulate material. This method involves obtaining non-contaminated water, then effusing the water throughout the bed of particles so that the particles are wetted, and passing an electric current through the bed. This results in contaminates adsorbed within the particles at the anode to react with HO⁻ radicals producing gases and contaminates adsorbed within the particles at the cathode to react with H⁺ radicals also producing gases.

The electrolytic oxidation/reduction cell stacks of this invention may be connected in series or parallel, in any combination. A series connection will enhance the extent of remediation, whereas a parallel connection will enhance the volumetric capacity of the system. A series/parallel system will improve both the extent of remediation and the volumetric capacity.

We have also discovered that a plurality of the electrolytic cells of this invention may be connected in a manner such that some cells have the porous electrode as the anode and other cells have the porous electrode as the cathode. These cells may be combined in the same stack. In this system, both organic contaminants and heavy metal contaminants may be simultaneously remediated in a continuous flow-through process. Alternatively, instead of using direct current, alternating current may be used to remediate the two types of contaminants.

### DRAWINGS

The invention is described in detail by reference to the drawings, in which:

FIG. 1a is a top cross-section view of the preferred embodiment of one electrolytic cell of this invention;

FIG. 1b is an exploded top cross-section view of the preferred embodiment of one electrolytic cell of this invention;

FIG. 1c is a stylized view of a water permeable fine mesh.

FIG. 2a is a velocity profile chart illustrating the effect of a stagnant boundary layer on a fluid stream passing over a surface;

FIG. 2b is a diagram showing the concentration gradient across a stagnant boundary layer of both pollutants and hydroxyl radicals where diffusion of the reactants is a rate-limiting step;

FIG. 3 shows the various side views of the preferred embodiment of the electrolytic cell stack of this invention;

FIG. 4 is a cut away view of the cell stack of this invention;

FIG. 5 is a cut away view of side A of the cell stack of this invention;

FIG. 6 is a diagram of a header of this invention;

FIG. 7 is a side view diagram of side D of the cell stack of this invention;

FIG. 8 is a side view diagram of side B of the cell stack of this invention;

FIG. 9 is a side view diagram of side C of the cell stack of this invention;

FIG. 10 is a three dimensional view of the arrangement of cells in a preferred embodiment of this invention;

FIG. 11 is a flow chart showing a method of implementing the invention; and

FIG. 12 is a flow chart showing a method of implementing the invention.

### REFERENCE DESIGNATION LIST

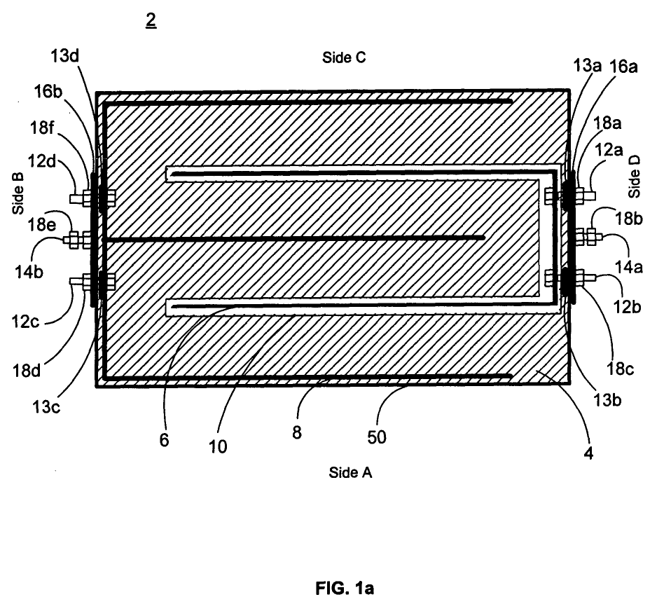

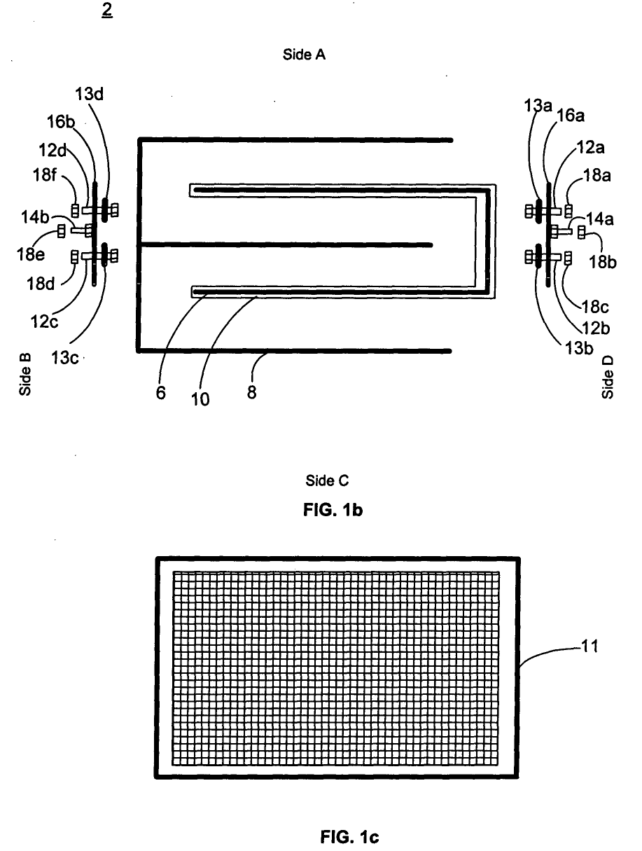

FIG. 1a

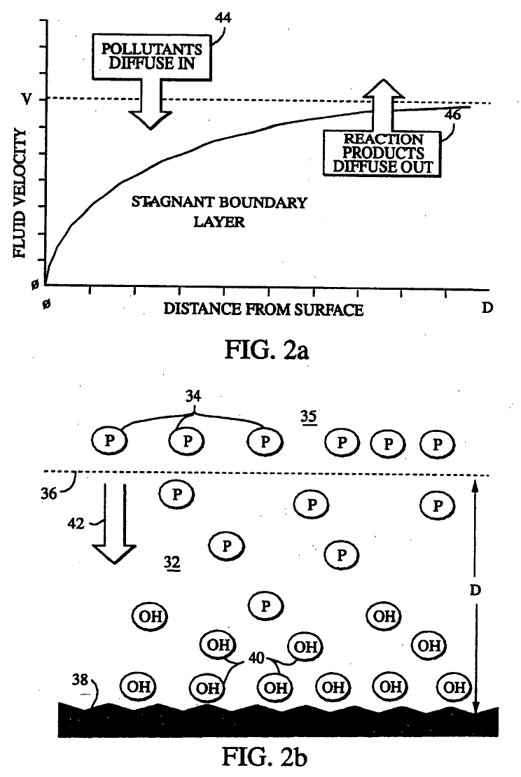

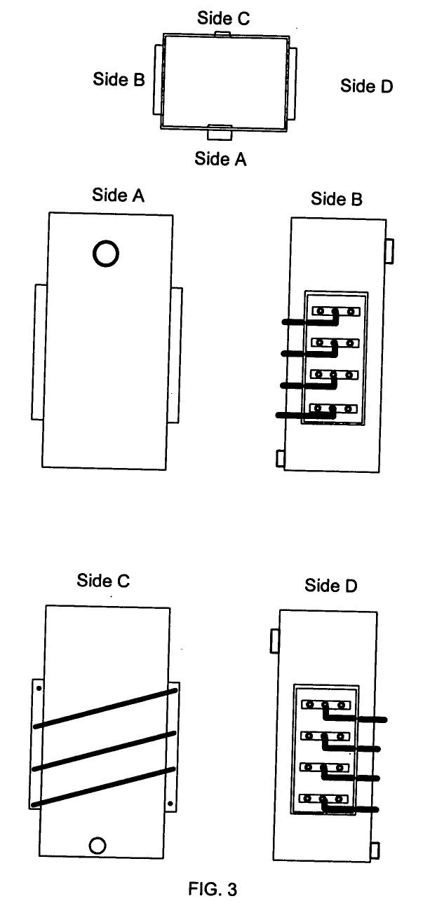

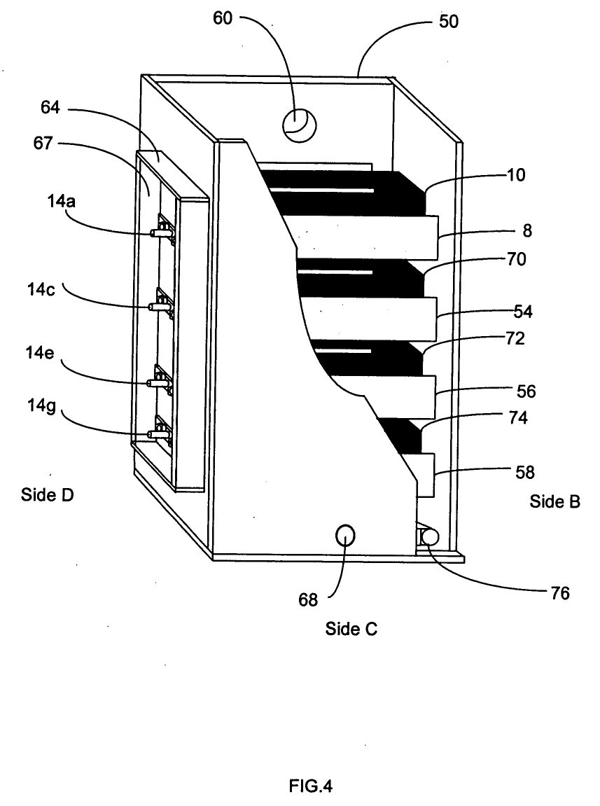

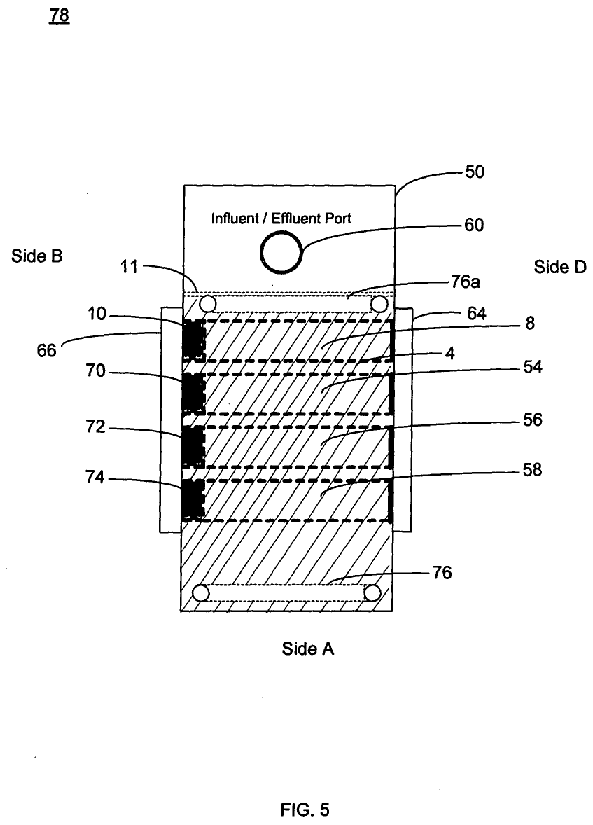

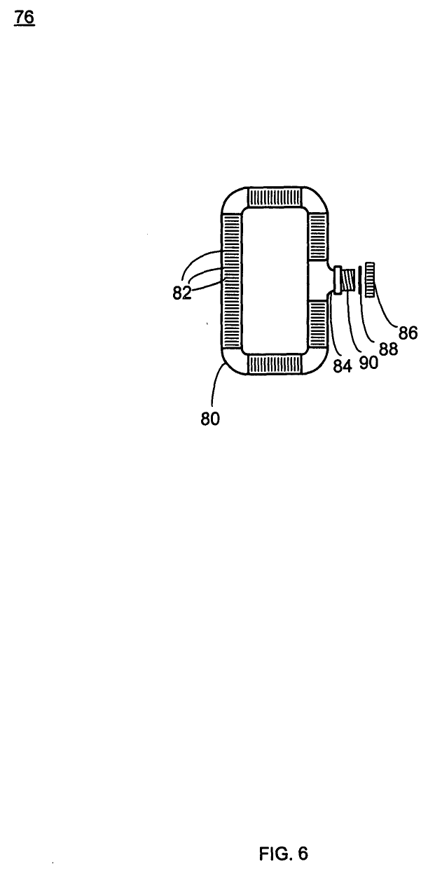

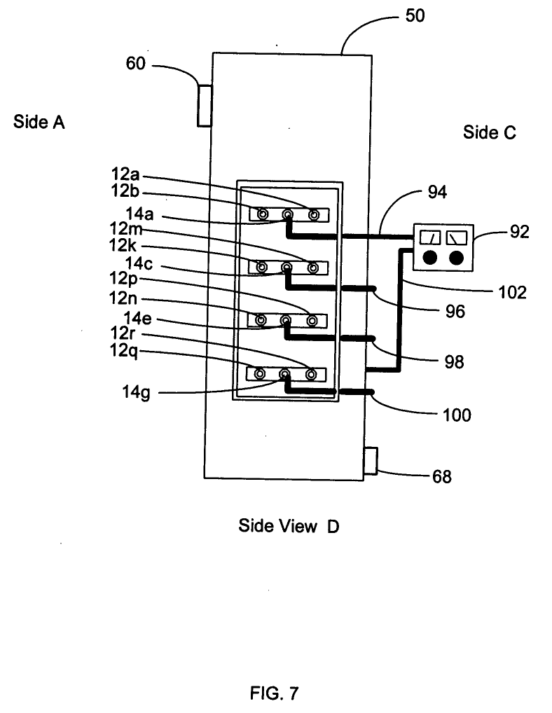

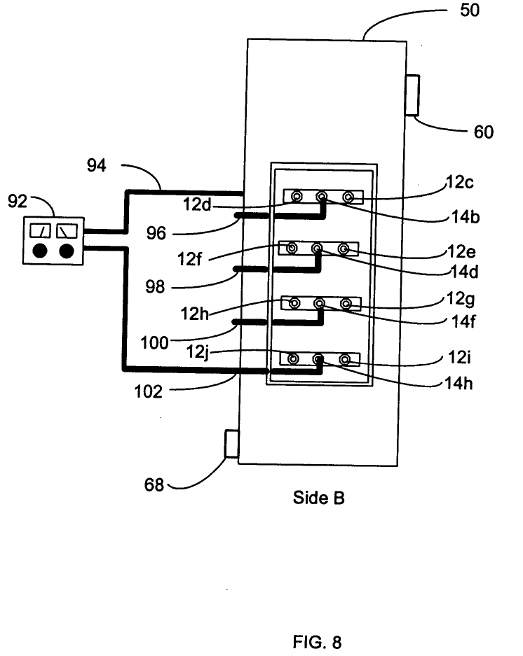

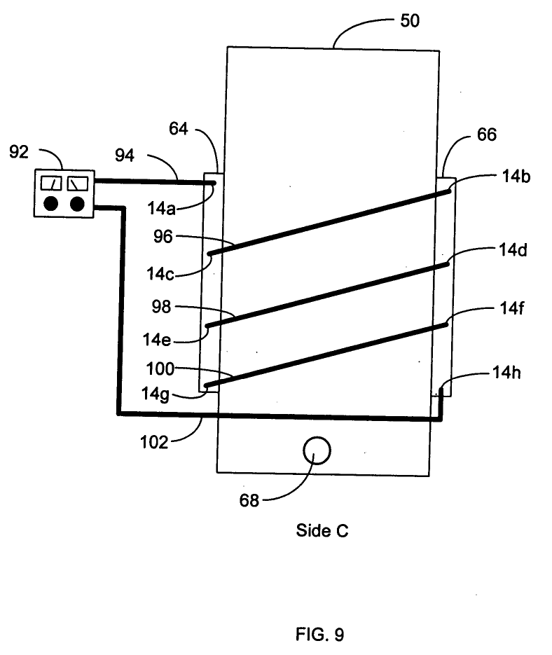

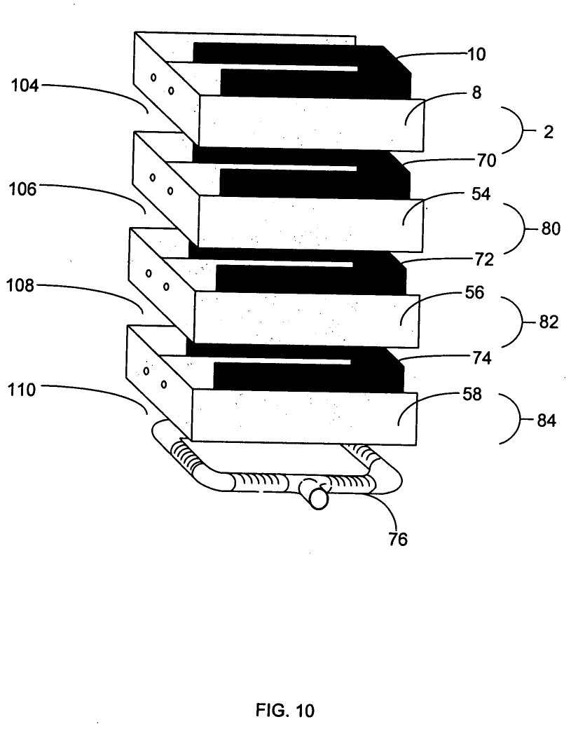

2 Cell
4 Electrode
6 U Plate
8 E Plate
10 Sleeve
12a Bolt (side D)
12b Bolt (side D)
12c Bolt (side B)
12d Bolt (side B)
13a rubber gasket (side D)
13b rubber gasket (side D)
13c rubber gasket (side B)
13d rubber gasket (side B)
14a electrical terminal (side D)
14b electrical terminal (side B)
16a plate (side D)
16b plate (side B)
18a nut (side D)
18b nut for terminal (side D)
18c nut (side D)
18d nut (side B)
18e nut for terminal (side B)
18f nut (side B)
50 Housing
   FIG. 1b.
2 Cell
4 Electrode
6 U Plate
8 E Plate
10 Sleeve
12a bolt (side D)
12b bolt (side D)
12c bolt (side B)
12d bolt (side B)
13a rubber gasket (side D)
13b rubber gasket (side D)
13c rubber gasket (side B)
13d rubber gasket (side B)
14a electrical terminal (side D)
14b electrical terminal (side B)
16a plate (side D)
16b plate (side B)
18a nut (side D)
18b nut for terminal (side D)
18c nut (side D)
18d nut (side B)
18e nut for terminal (side B)
18f nut (side B)
   FIG. 1c
11 water permeable fine mesh
   FIG. 2a
44 diffusing pollutants
46 reaction products diffusing out
V velocity
D distance
   FIG. 2b
32 boundary layer
34 pollutant molecules
35 fluid
36 interface thickness
38 anode surface
40 radicals
42 diffusion
D distance
   FIG. 3 No reference designators
   FIG. 4 Cut away view
8 E plate
10 sleeve
14a electrical terminal (side D)
14c electrical terminal (side D)
14e electrical terminal (side D)
14g electrical terminal (side D)
50 housing
54 E plate
56 E plate
58 E plate
60 influent/effluent port
68 influent/effluent port
70 sleeve
72 sleeve
74 sleeve
76 header
   FIG. 5. Side external view of A
4 Electrode
8 E shape plate
10 Sleeve
11 water permeable fine mesh
50 housing
54 E shape plate
56 E shape plate
58 E shape plate
60 influent/effluent port
64 cover for electrical terminals
66 cover for electrical terminals
70 sleeve
72 sleeve
74 sleeve
76 header
76a header
78 side view of A
   FIG. 6 Header
76 header
80 header elbow
82 slots
84 T
90 threads
88 gasket
86 tank adapter ring
   FIG. 7 side external view of D
12a bolt
12b bolt
12k bolt
12m bolt
12n bolt
12p bolt
12q bolt
12r bolt
14a electrical terminal
14c electrical terminal
14e electrical terminal
14g electrical terminal
50 housing
60 influent/effluent port
68 influent/effluent port
92 power supply
94 power cable from electrical terminal 14a to power supply 92
96 power cable from electrical terminal 14c to 14b (not shown)
98 power cable from electrical terminal 14e to 14e (not shown)
100 power cable from electrical terminal 14g to 14g (not shown)
102 power cable from electrical terminal 14h (not shown) to power supply 92
   FIG. 8 side external view of B
12c bolt
12d bolt
12e bolt
12f bolt
12g bolt
12h bolt
12i bolt
12j bolt
14b electrical terminal
14d electrical terminal
14f electrical terminal
14h electrical terminal
50 housing
60 influent/effluent port
68 influent/effluent port
92 power supply
94 power cable from electrical terminal 14a (not shown) to power supply 92
96 power cable to electrical terminal 14b to 14c (not shown)
98 power cable to electrical terminal 14d to 14e (not shown)
100 power cable to electrical terminal 14f to 14g (not shown)
102 power cable between electrical terminal 14h and power supply 92
   FIG. 9 Side external view of side C
14a electrical terminal
14c electrical terminal
14e electrical terminal
14g electrical terminal
14b electrical terminal
14d electrical terminal
14f electrical terminal
14h electrical terminal
50 housing
64 cover for electrical terminals
66 cover for electrical terminals
68 influent/effluent port
92 power supply
94 wire from terminal 14a to power supply 92
96 wire from terminal 14c to terminal 14b
98 wire from terminal 14e to terminal 14d
100 wire from terminal 14g to terminal 14f
102 wire from terminal 14h to power supply 92
   FIG. 10 view of cell stack
2 cell
8 E plate
10 sleeve
54 E plate
56 E plate
58 E plate
70 sleeve
72 sleeve
74 sleeve
76 header
80 cell
82 cell
84 cell
104 space
106 space
108 space
110 space

### DETAILED DESCRIPTION OF THE BEST MODE

The following detailed description illustrates the invention by way of example, not by way of limitation of the principles of the invention. This description will clearly enable one skilled in the art to make and use the invention, and describes several embodiments, adaptations, variations, alternatives and uses of the invention, including what we presently believe is the best mode of carrying out the invention.

An electrolytic oxidation/reduction cell 2 of this invention is shown in cutaway top view in FIG. 1 a. The cell 2, while shown as the preferred configuration may alternately be configured in any geometry that embodies the novel attributes of the electrolytic cell of this invention, including flat plate geometries.

For purposes of this disclosure, the porous electrode of the electrolytic cell of this invention will be described as the “E” electrode 4 while the non-porous electrode will be described as the “U” electrode 6. In alternate embodiments, either the E electrode 4 or the U electrode 6, or both, may be porous. If direct current is supplied to the cell, the porous electrode may be used as either an anode or as a cathode. The cell comprises an E shaped plate 8 connecting the E electrode 4 to a source of electric power through electric terminals 14a and 14b. The U electrode 6 is arranged so its prongs are spaced among material of the E electrode 4. A porous electric insulator sleeve, that is an ion permeable membrane, 10 separates the U electrode 6 from the E electrode 4.

The U electrode 6 and the plate 8 are electrically conductive and preferably inert to an aqueous solution over a wide pH range (e.g., approximately 3.0-10.5), and is constructed from preferably inert or non-corroding materials such as stainless steel, carbon, gold, platinum, titanium, materials plated with these non-corroding materials, and the like. Other materials, equally preferred, include composites where the metals such as silver, platinum, or gold plated ceramics, or conductive plastics, are plated on non-conductive substrates.

The porous E electrode 4 may be of any porous, conducting material, but preferably one that has a high surface area and a large number of reactive sites to catalyze the various reactions occurring on or near the surface of the material of the porous electrode. Such materials include activated carbon, granulated activated carbon, metal plated activated carbon, and other metallic materials including, but not limited to silver, gold, ruthenium, rhodium, and platinum; sintered metal powders; sintered conductive plastics; metal mesh; and conductive, open-cell sponges. Note that the quality of an activated carbon porous electrode must be high to minimize the amount of carbon fines. Such fine particulate carbon will compete with the organic contaminants for the oxygen radical, resulting in a reduced efficiency of the cell. This problem may be mitigated, however, by plating the carbon with a relatively unreactive metal such as silver, gold, platinum, and the like. The highly conductive surface, and high surface area of the porous electrode results in a low current density, thus preventing formation of hot spots and ensuring minimum polarization of the electrode.

The porous E electrode 4 completely fills the space between the E plate 8 and the U electrode 6. It also fills any gaps between the plate 8, U electrode 6, and cell housing 50. The distribution of the porous E electrode 4 material should be uniform and without gaps so that neither fluid nor current can channel around the electrodes. That is, both fluid and current flow should be evenly distributed throughout the porous E electrode 4.

The U electrode 6 is wrapped around and insulated from the porous electrode 4 by a porous electrically insulating sleeve (that is an ion permeable membrane) 10. The sleeve 10 may be any non-conductive, porous material, including but not limited to foraminous plastic membranes; plastic or fabric screens and meshes, and the like, to form a porous, insulating sleeve around the U electrode 6. Alternatively, the sleeve 10 may be disposed around the porous E electrode 4; the requirement is that placement of the sleeve must electrically separate the E electrode 4 from the U electrode 6.

The E plate 8 and the U electrode 6 have electric bolts 12a, 12b, 12c, and 12d each mounting respective rubber gaskets 13a, 13b, 13c, and 13d. In turn, the bolts 12a, 12b, 12c, and 12d are attached to plates 16a and 16b by nuts 18a, 18b, 18c, and 18d. Plate 16a includes electric connector 14a and plate 16b includes electric connector 14b. The electric connectors 14a and 14b may be in turn connected to a source of alternating current; a “hot” connection and a “neutral” connection. Alternatively, connectors 14a and 14b may be connected to source of direct current. In that case, the connection to the positive side is the anode and the connection to the negative side is the cathode. Removal of organics (i.e., oxidation) is facilitated by having the U electrode 6 in electrical connection with the negative side of a source of direct current.

Oxidation of the organic contaminants occurs by the oxidation of hydroxyl ion into the hydroxyl radical at the anode surface. The hydroxyl radical is short-lived (@1 msec) and combines with another hydroxyl radical to form one molecule of water and an oxygen radical. The oxygen radical is a powerful oxidizer and combines with organic carbon compounds and nitrogen compounds to form carbon dioxide and NOₓ compounds. The concentration of hydroxyl radical may be favored by increasing the pH of the contaminated fluid. Once treated the pH can be adjusted back to any desired level. The addition of ferrous sulfate to provide a ferrous ion stabilizes and enhances the formation of hydroxyl radicals.

Other methods of altering the concentration of hydroxyl radical are well known in the art and include controlling conductivity, water softing, introducing oxidizing agents, introducing reducing agents, and exposing to ultraviolet light.

Using a high surface area, porous E electrode 4 as the cathode is preferred when metals are the contaminants of interest. That is where removal of metals is desired, the porous E electrode 4 is negatively charged with respect to the U electrode 6, thus reducing the metals from the water. If both electrodes are porous or alternating current is used, both metals and organic contaminants may be removed from the water simultaneously.

FIG. 1b is an exploded view of FIG. 1a to more clearly show the various components. Electrode 4 is deleted from the drawing so to give a clearer view of the relationship between U electrode 6, sleeve 10, and E plate 8. Housing 50 is also removed from the drawing. Clearly shown are bolts 12a, 12b, 12c, and 12d. Positioned next to the bolts are nuts 18a, 18c, 18d, and 18f. Plate 16a and 16b include, respectively, electrical terminals 14a and 14b. Nuts 18b and 18e are designed to attach power cables (not shown) to respective terminals 14a and 14b. Rubber gaskets 13a and 13b provide a water tight and electrical insulating barrier between plate 16a and sleeve 10. Likewise, gaskets 13c and 13d provide a water tight barrier between plate 16b and plate 8.

Referring to FIG. 1c, water permeable fine mesh 11 fits over cell 2 so that no fluid or electric current can channel around it. It is made of non-conductive porous polymeric material such as polyesters, nylon, plastic, rubber, and various polymers. It may be connected to the inside edge of housing 50 by various means including glue, non-conductive solder, clamping, screws, and welding. In practice, placing weights on top of mesh 11 holds it in place.

The following theory as to the thermodynamics, which govern the rate of reaction, is presented by way explanation and not by limitation of the scope of the claims or as to the subject matter of this invention. Oxidation of both dissolved and particulate aqueous contaminants occurs in part by way of the hydroxyl radical intermediate at the surface of the anode. Because the hydroxyl radical intermediate is short-lived, oxidation occurs principally at the surface of the porous anode. Accordingly, the porous anode must have a high surface area in order to maximize the reactive surface area, thus maximizing water contact.

Surface reactions may be limited, however, in their reaction rates by the amount reactant available. In this case, the rate at which pollutant contaminants reach the surface may limit the rate of oxidation in that diffusion transport becomes predominant near the anode surface. FIG. 2a is the velocity profile of a flowing fluid next to a surface. At the surface (and assuming no slip flow), the velocity of the fluid is zero. At some distance D, the velocity of the fluid is equal to the velocity, V, of the bulk fluid stream. At distances less than D, the fluid velocity is less than V; i.e., it is stagnated. Consequently, in the stagnant boundary layer region, transport of bulk fluid contaminants to the surface of the anodic material occurs in part by diffusion, as convective transport becomes less predominant as the fluid velocity approaches zero.

Referring now to FIG. 2b, the remediation of pollutant molecules is dependent upon the concentration of pollutant molecules 34 at the anode surface 38 as this is where the hydroxyl and oxygen radicals 40 are concentrated. Accordingly, the reaction rate is dependent upon the rate of diffusion 42 of the pollutants to the anode surface which, in turn, will determine the concentration of available reactant (i.e., pollutant molecules) available to react with the hydroxyl and oxygen radicals. By reducing the interface thickness 36 of the stagnant boundary layer, the concentration of pollutant molecules at the anode surface 38 is increased because the diffusion time required to reach the surface of the anode also decreases as the boundary layer thickness 36 decreases.

The mass transport of pollutant molecules from the bulk fluid 35 to the anode surface (or alternately of hydroxyl radicals from the anode surface through the stagnant boundary layer) is dependent upon several variables including boundary layer thickness, temperature, bulk fluid velocity, bulk fluid pollutant concentration and fluid density. A high surface area increases the bulk fluid velocity by reducing the void volume of the porous anode, thus reducing the thickness of the stagnant boundary layer, resulting in an increase in the rate at which pollutants reach the anode surface, thereby increasing the reaction rate. The high contact area associated with the high surface area also minimizes the amount of time necessary to process the contaminated water. By increasing the surface area, the total flux of pollutant molecules 44 inbound through the boundary layer, or conversely the flux of hydroxyl and oxygen radicals 46 outbound through the boundary layer, is increased (see FIG. 2a). Further, by increasing the ratio of anode surface area to fluid volume, the mean contact time of pollutant molecules with the anode surface is increased thus increasing the extent of reaction.

A novel feature of the electrolytic cell of this invention is that, unlike a standard carbon absorption column, the carbon seldom needs to be recharged or replaced because the absorbed organic contaminants are continuously being oxidized and the reaction product, carbon dioxide, is removed either as a dissolved gas, or as a gas. The advantage of using activated carbon is that it has the property of absorbing organic contaminants onto the carbon surface and retaining it. This results in a high surface concentration of organic reactant thus significantly improving the thermodynamics for the oxidation of these reactants, and improving the efficiency of the cell. Because the pollutants are concentrated at the surface of the anode for immediate reaction with the hydroxyl and oxygen radicals, diffusion of the pollutants through the stagnant boundary layer is no longer a limiting factor. An alternately preferred method for removing organic contaminants is to pump the contaminated influent through the electrolytic cell without applying an electric potential to the electrodes, essentially allowing the cell to perform as a carbon absorption cell. Electric power may then be applied periodically to oxidize the adsorbed organic contaminants, thus renewing the carbon anode. Other conducting materials capable of adsorbing organic contaminants may also be used, including aluminum oxide, ceramics, and the like.

A novel feature of the electrolytic cell of this invention is that the same cell 2 shown in FIG. 1a can be used to remove metal contaminants from the water influent. This is accomplished by connecting the porous E electrode 4 to the negative side of a supply of direct current and the U electrode to the positive side to provide a porous cathode. As a result, the metals are reduced onto the negatively charged porous anode surface. The reduced metals may be removed from the porous cathode by acid leaching.

FIG. 3 shows 5 external views of a four-cell stack configuration.

Referring to FIG. 4, a side cutaway view four-cell stack is illustrated. However, it must be noted that the number of cells in a stack is not limited; cells may be any number greater than or equal to one.

Housing 50 encloses 4 cells (not numbered). An influent/effluent port 60 permits liquid to flow into and out of the housing 50. Likewise influent/effluent port 68 permits liquid to flow into and out of the housing 50. At any given time, influent may flow into either port 68 or 60 and flow out of the remaining effluent port. In addition, flow may alternate into and out of ports 68 and 60 during a given space of time.

Porous insulating sleeves 10, 70, 72, and 74, shown in partial view, cover individual electrodes (not shown). Electric contact enclosure cover 64, with clear cover window 67, on side D of housing 50, houses electric terminals 14a, 14c, 14e, and 14g, which are extensions of plates 16a and 16b (not shown). In passing it should be noted that in the preferred embodiment, clear cover window 67 permits visual inspection of the connection between electric terminals 14a, 14c, 14e, and 14g and respective power cables. However, the cover may be opaque if desired.

Partial views of E plates 8, 54, 56, and 58 are shown. Also shown is a portion of header 76. Not shown is electrode 4. This material completely fills the space from the bottom of housing 50 (i.e., beneath header 76) to the top of sleeve 10. This material must be distributed so that neither fluid nor electric current may channel past it.

FIG. 5 is a cut away view of side A. Electrode 4 is shown as hatched lines from the bottom of housing 50 to the bottom of water permeable fine mesh 11. Header 76 is near the bottom of housing 50, while optional header 76a is below mesh 11. Cover 64 for electrical terminals protrudes from side D, while cover 66 protrudes from side B. Influent/effluent port 60 is between mesh 11 and top of housing 50.

E plates 8, 54, 56 and 58 are in the midsection of housing 50 and have space (filled by electrode 4) between each of them. Shown partially are sleeves 10, 70, 72, and 74 which obscure U electrodes.

FIG. 6 is a detailed view of distribution header 76. A perimeter is formed by perforated pipe 80. In one embodiment, perforations 82 comprise slots. However, other types of foraminous perforations will also give acceptable results. On one side of the perimeter is a T-fitting 84. The T-fitting terminates in a threaded pipe nipple 90. Rubber gasket 88 and tank adapter ring 86 fit over threaded pipe nipple 90.

Optional header 76a comprises a mirror image of header 76.

FIG. 7 is a view of side D with electric contact enclosure cover 64 removed. Electric terminals 14a, 14c, 14e, and 14g are exposed. Attached to electric terminals 14a, 14c, 14e, and 14h are power cables 94, 96, 98, and 100, respectively. Electric power, whether AC or DC, is supplied via power supply 92 to the electric terminal 14a through respective power cable 94.

FIG. 8 is a view of side B with electric contact enclosure cover 66 removed. Electric terminals 14b, 14d, 14f, and 14h are exposed. Attached to terminals 14b, 14d, 14f, and 14h are power cables 96, 98, 100, and 102, respectively. Electric power, whether AC or DC, is supplied via power supply 92 to the electric terminal 14h through respective power cable 102.

FIG. 9 is an elevation view of side C. The implementation shown is an electrical series arrangement of cells 2, 54, 56, and 58 (see FIG. 10). Electric terminal 14h of cell 58 is connected to the power supply 92 via power cable 102. Electric terminal 14g of cell 58 is connected to electric terminal 14f of cell 56 via power cable 100. Electric terminal 14e of cell 56 is connected to electric terminal 14d of cell 54 via power cable 98. Electric terminal 14c of cell 54 is connected to electric terminal 14b of cell 2 via power cable 96. Electric terminal 14a is connected to power supply 92 via power cable 94, thus completing the circuit.

While the particular configuration illustrated in FIGS. 7, 8, and 9 is an electrical serial connection of the cells, it will be apparent to one skilled in the art how to connect the cells in parallel or in any combination of serial/parallel connection.

FIG. 10 shows the relative spacing between cells 2, 80, 82, and 84. Cell 2 is depicted by sleeve 10 and E plate 8. The space between cell 2 and cell 80 is depicted by space 104. Cell 80 is depicted by sleeve 70 and E plate 54. The space between cell 80 and cell 82 is depicted by space 106. Cell 82 is depicted by sleeve 72 and E plate 56. The space between cell 82 and cell 84 is depicted by space 108. Cell 84 is depicted by sleeve 74 and E plate 58. The space between cell 84 and header 76 is depicted by space 110.

The stack of cells may be reversed top to bottom, may be placed on its side, and may reflected left to right (or right to left) without affecting the efficiency of the operation of the stack.

It is clear to a person of ordinary skill in the art that the stack may include as many cells as is necessary to achieve the desired level of remediation. Further, the cells may be set up to treat both organics and inorganic contaminants. For example, the system may be set up so that a stack of two or more cells is pH adjusted and the porous electrodes therein polarized to provide for the oxidation of organic contaminants. A subsequent downstream stack of two or more cells may be set up so that the pH is adjusted and the correct polarity established for the reduction of metals onto the electrically conductive porous electrode. Prior to final discharge the pH is re-adjusted to conform to the appropriate discharge standards. By connecting the cells in this fashion, both organic and inorganic contaminants are removed from the water.

Unlike conventional chemical treatment of water, the cell, system and methods of this invention do not contribute to the amount of total dissolved solids (TDS) in the discharged effluent. In fact, no chemicals need be used to pretreat the Water, including the use of oxidizing agents. Unlike carbon columns for removing organic contaminants, the carbon or other conductive matrix used in the cell of this invention need never be replaced or recharged. The system of this invention may be made “application” or “process specific” thus permitting source treatment at the process equipment level, thus allowing, in the case of industrial wastewater, discharge to the POTW directly from the process itself (as compared to combining the waste streams and treating a plants entire wastewater discharge at end-of-pipe).

### EXAMPLE 1

Remediation of Phenol Contaminated Industrial Wastewater Using Four Electrolytic Cell in One Vessel

A sample of industrial wastewater containing 1400 ppm of phenol was initially filtered through 1.0 Micron filter and then introduced in to recirculation tank at a rate of 2.0 gpm. A flow of 20 gpm was taken from circulation tank containing 50 gals of water and introduced into a four electrolytic cell vessel as shown in FIG. 4. All four cells were connected in series arrangement. A 30 amp AC electrical current was applied at 30 volts (power consumption of 900 watts). A 2.0 gpm flow was discharged from the effluent of the electrolytic cell and the 18 gpm balance were returned to the recirculation tank. The experiment was conducted for 75 minutes and 150 gals of wastewater were treated.

TABLE I

| | DETECTION | SAMPLE |
|---|---|---|
| | LIMIT | RESULTS |
| SAMPLE | (ppm) | (ppm) |
| Phenol Prior to Treatment | 1.0 | 1400 |
| Phenol After Single-Pass | 1.0 | 40.0 |

The single pass at 2 gpm resulted in a 97% reduction in Phenol contamination.

### EXAMPLE 2

Remediation of Phenol Contaminated Industrial Wastewater Using Four Electrolytic Cell in One Vessel

A sample of industrial wastewater containing 1400 ppm of phenol was initially filtered through 1.0 Micron filter and then introduced in to recirculation tank at a rate of 3.0 gpm. A flow of 20 gpm was taken from circulation tank containing 50 gals of water and introduced in to a four electrolytic cell vessel as shown in FIG. 4. All four cells were connected in series arrangement. A 30 amp AC electrical current was applied at 30 volts (power consumption of 900 watts). A 3.0 gpm flow was discharged from the effluent of the electrolytic cell and the 17 gpm balance were returned to the recirculation tank. The experiment was conducted for 75 minutes and 150 gals of wastewater were treated.

TABLE II

| | DETECTION | SAMPLE |
|---|---|---|
| | LIMIT | RESULTS |
| SAMPLE | (ppm) | (ppm) |
| Phenol Prior to Treatment | 1.0 | 1400 |
| Phenol After Single-Pass | 1.0 | 50.0 |

The single pass at 3 gpm resulted in a 96.4% reduction in Phenol contamination in wastewater.

### EXAMPLE 3

Remediation of Phenol Contaminated Industrial Wastewater Using Four Electrolytic Cell in One Vessel

A sample of industrial wastewater containing 1400 ppm of phenol was initially filtered through 1.0 Micron filter and then introduced in to recirculation tank at a rate of 1.0 gpm. A flow of 20 gpm was taken from circulation tank containing 50 gals of water and introduced in to a four electrolytic cell vessel as shown in FIG. 4. All four cells were connected in series arrangement. A 30 amp AC electrical current was applied at 30 volts (power consumption of 900 watts). A 1.0 gpm flow was discharged from the effluent of the electrolytic cell and the 18 gpm balance were returned to the recirculation tank. The experiment was conducted for 75 minutes and 150 gals of wastewater were treated.

TABLE III

| | DETECTION | SAMPLE |
|---|---|---|
| | LIMIT | RESULTS |
| SAMPLE | (ppm) | (ppm) |
| Phenol Prior to Treatment | 1.0 | 1400 |
| Phenol After Single-Pass | 1.0 | 8.0 |

The single pass at 1 gpm resulted in a 99.4% reduction in Phenol contamination in wastewater.

### EXAMPLE 4

Remediation of Triethanolamine Contaminated Water Using Four Electrolytic Cell in One Vessel

A sample of industrial wastewater containing 10,000 ppm of phenol was initially filtered through 1.0 Micron filter and then introduced in to recirculation tank at a rate of 1.0 gpm. A flow of 20 gpm was taken from circulation tank containing 50 gals of water and introduced in to a four electrolytic cell vessel as shown in FIG. 4. All four cells were connected in series arrangement. A 30 amp AC electrical current was applied at 40 volts (power consumption of 1200 watts). A 1.0 gpm flow was discharged from the effluent of the electrolytic cell and the 19 gpm balance were returned to the recirculation tank. The experiment was conducted for 75 minutes and 150 gals of wastewater were treated.

TABLE IV

| | DETECTION | SAMPLE |
|---|---|---|
| | LIMIT | RESULTS |
| SAMPLE | (ppm) | (ppm) |
| Triethanolamine Prior to Treatment | 1.0 | 10,000 |
| Triethanolamine After Single-Pass | 1.0 | ND |

The single pass at 1 gpm resulted in a 99.99% reduction in Triethanolamine contamination in wastewater.

### EXAMPLE 5

Remediation of Perchlorate and Nitrate Contaminated Drinking Water Using Four Electrolytic Cell in One Vessel

A sample of Drinking Water containing 5.4 ppb of perchlorate 37 ppm of nitrate was initially filtered through 1.0 Micron filter and then introduced in to recirculation tank at a rates of 5.0, 10.0, 15.0 gpm. A flow of 20 gpm was taken from circulation tank containing 50 gals of water and introduced in to a four electrolytic cell vessel as shown in FIG. 4. All four cells were connected in series arrangement. A 30 amp AC electrical current was applied at 17 volts (power consumption of 510 watts). A 5.0, 10.0, 15.0 gpm flow was discharged from the effluent of the electrolytic cell and the 15.0, 10.0, and5.0 gpm balance were returned to the recirculation tank. The experiment was conducted for 30 minutes for each 5.0, 10.0, 15.0 gpm flow rates. 150 gals, 300 gals and 450 gals of drinking water were treated.

TABLE V
(Perchlorate)

| | FLOW | DETECTION | SAMPLE |
|---|---|---|---|
| | RATE | LIMIT | RESULTS |
| SAMPLE | gpm | ppb) | (ppb) |
| Perchlorate Prior to Treatment | — | 2.0 | 5.4 |
| Perchlorate After Single-Pass | 5.0 | 2.0 | ND |
| Perchlorate After Single-Pass | 10.0 | 2.0 | ND |
| Perchlorate After Single-Pass | 15.0 | 2.0 | ND |

The single pass at 5.0, 10.0, and 15.0 gpm resulted in a 99.99% reduction in perchlorate contamination in drinking water.

TABLE VI
(Nitrate)

| | FLOW | DETECTION | SAMPLE |
|---|---|---|---|
| | RATE | LIMIT | RESULTS |
| SAMPLE | gpm | (ppm) | (ppm) |
| Nitrate Prior to Treatment | — | 0.5 | 37 |
| Nitrate After Single-Pass | 5.0 | 0.5 | 3.1 |
| Nitrate After Single-Pass | 10.0 | 0.5 | 4.5 |
| Nitrate After Single-Pass | 15.0 | 0.5 | 6.4 |

The single pass at 5.0, 10.0, and 15.0 gpm resulted in 91.6, 87.8, and 82.7 percent reduction in nitrate contamination in drinking water.

### EXAMPLE 6

Remediation of Perchlorate and Nitrate Contaminated Drinking Water Using Four Electrolytic Cell in One Vessel

A sample of Drinking Water containing 5.4 ppb of perchlorate 37 ppm of nitrate was initially filtered through 1.0 Micron filter and then introduced in to recirculation tank at a rates of 5.0, 10.0, 15.0 gpm. A flow of 20 gpm was taken from circulation tank containing 50 gals of water and introduced in to a four electrolytic cell vessel as shown in FIG. 4. All four cells were connected in series arrangement. A 25 amp DC electrical current (Anodic Reaction) was applied at 48 volts (power consumption of 1200 watts). A 5.0, 10.0, 15.0 gpm flow was discharged from the effluent of the electrolytic cell and the 15.0, 10.0, and5.0 gpm balance were returned to the recirculation tank. The experiment was conducted for 30 minutes for each 5.0, 10.0, 15.0 gpm flow rates. 150 gals, 300 gals and 450 gals of drinking water were treated.

TABLE VII
(Perchlorate)

| | FLOW | DETECTION | SAMPLE |
|---|---|---|---|
| | RATE | LIMIT | RESULTS |
| SAMPLE | gpm | (ppb) | (ppb) |
| Perchlorate Prior to Treatment | — | 2.0 ppb | 5.4 |
| Perchlorate After Single-Pass | 5.0 | 2.0 ppb | ND |
| Perchlorate After Single-Pass | 10.0 | 2.0 ppb | ND |
| Perchlorate After Single-Pass | 15.0 | 2.0 ppb | ND |

The single pass at 5.0, 10.0, and 15.0 gpm resulted in a 99.99% reduction in perchlorate contamination in drinking water.

TABLE VIII
(Nitrate)

| | FLOW | DETECTION | SAMPLE |
|---|---|---|---|
| | RATE | LIMIT | RESULTS |
| SAMPLE | gpm | (ppm) | (ppm) |
| Nitrate Prior to Treatment | — | 0.5 | 37 |
| Nitrate After Single-Pass | 5.0 | 0.5 | 1.7 |
| Nitrate After Single-Pass | 10.0 | 0.5 | 1.9 |
| Nitrate After Single-Pass | 15.0 | 0.5 | 3.2 |

The single pass at 5.0, 10.0, and 15.0 gpm resulted in 97.0, 95.1, and 91.3 percent reduction in Nitrate contamination in drinking water.

### EXAMPLE 7

Remediation of Perchlorate and Nitrate Contaminated Drinking Water Using Four Electrolytic Cell in One Vessel

A sample of Drinking Water containing 5.4 ppb of perchlorate 37 ppm of nitrate was initially filtered through 1.0 Micron filter and then introduced in to recirculation tank at a rates of 5.0, 10.0, 15.0 gpm. A flow of 20 gpm was taken from circulation tank containing 50 gals of water and introduced in to a four electrolytic cell vessel as shown in FIG. 4. All four cells were connected in series arrangement. A 15 amp DC electrical current (Cathodic Reaction) was applied at 45 volts (power consumption of 675 watts). A 5.0, 10.0, 15.0 gpm flow was discharged from the effluent of the electrolytic cell and the 15.0, 10.0, and 5.0 gpm balance were returned to the recirculation tank. The experiment was conducted for 30 minutes for each 5.0, 10.0, 15.0 gpm flow rates. 150 gals, 300 gals and 450 gals of drinking water were treated.

TABLE IX
(Perchlorate)

| | FLOW | DETECTION | SAMPLE |
|---|---|---|---|
| | RATE | LIMIT | RESULTS |
| SAMPLE | gpm | (ppb) | (ppb) |
| Perchlorate Prior to Treatment | — | 2.0 ppb | 5.4 |
| Perchlorate After Single-Pass | 5.0 | 2.0 ppb | ND |
| Perchlorate After Single-Pass | 10.0 | 2.0 ppb | ND |
| Perchlorate After Single-Pass | 15.0 | 2.0 ppb | ND |

The single pass at 5.0, 10.0, and 15.0 gpm resulted in a 99.99% reduction in perchlorate contamination in drinking water.

TABLE X
(Nitrate)

| | FLOW | DETECTION | SAMPLE |
|---|---|---|---|
| | RATE | LIMIT | RESULTS |
| SAMPLE | gpm | (ppm) | (ppm) |
| Nitrate Prior to Treatment | — | 0.5 | 37 |
| Nitrate After Single-Pass | 5.0 | 0.5 | 3.5 |
| Nitrate After Single-Pass | 10.0 | 0.5 | 4.4 |
| Nitrate After Single-Pass | 15.0 | 0.5 | 5.3 |

The single pass at 5.0, 10.0, and 15.0 gpm resulted in 90.5, 88.1, 83.0 percent reduction in nitrate contamination in drinking water.

The single pass at 1 gpm resulted in a 25% reduction in acetone contamination, even with a low surface area, non-adsorbing stainless steel packing.

### EXAMPLE 8

A thirty four gallon sample of industrial waste water was spiked with additional acetone to raise the acetone concentration to 280 ppm. A triple stage cascaded remediation system was set up. Flow rates in each stage were set to 1 gpm, and supply voltages for each stage were set to 20 volts, at 20 amperes. The system was permitted to run for forty minutes prior to taking samples at each cascade point. The sample results are summarized as follows:

TABLE XI

| SAMPLE | ACETONE TEST RESULT (ppm) |
|---|---|
| Prior to Treatment | 280 |
| First Cell | 130 |
| Second Cell | 56 |
| Third Cell | 19 |

Concentrations of acetone decrease dramatically in going from one stage to the next. It was later determined that the electric current settings of the cells were set much lower than would ordinarily be required for an initial acetone concentration of 280 ppm. Setting the current to a higher level would further improve the results.

### EXAMPLE 9

Remediation of Contaminated Groundwater

A sample of groundwater was single-passed through the electrolytic cell of this invention. The results are summarized in Table XII.

TABLE XII

| | CONC. PRIOR | CONC. AFTER |
|---|---|---|
| | TO TREATMENT | TREATMENT |
| CONTAMINANT | (ppm) | (ppm) |
| Dichlorodifluoromethane | 0.60 | 0.006 |
| Vinyl chloride | 0.77 | 0.003 |
| 1,1-Dichloroethene | 0.34 | ND |
| Methylene Chloride | 25.1 | 0.09 |
| 1,1-Dichloroethane | 2.02 | 0.006 |
| Chloroform | 2.01 | 0.006 |
| 1,1,1 TCA | 24.3 | 0.005 |
| 1,2-Dichloroethane | 2.62 | 0.005 |
| Benzene | 0.38 | ND |
| Trichloroethene | 28.3 | 0.002 |
| Toluene | 18.0 | 0.007 |
| 1,1,2-Trichloroethane | 1.46 | 0.001 |
| Tetrachloroethane | 53.1 | ND |
| Ethylbenzene | 2.52 | 0.001 |
| 1,1,2,2-Tetrachloroethane | 1.47 | ND |
| TOTALS | 162.99 | 0.132 |

ND = non-detectable

The results achieved after a single pass through the electrolytic cell of this invention are less than two orders of magnitude less than the original sample concentrations.

### EXAMPLE 10

Remediation of BTEX, MTBE and Petroleum derivatives in contaminated ground water. The cell consist four sets of electrodes in one vessel (size 21″×19″×53″ H) described as above. The cell had 220 lbs. of GAC.

Ground water was pumped from the underground well a rate of 1.0 gallon per minute in to the filtration system equipped two stage filters 20 and 1.0 micron. The filtered water was introduced in to a low of 19 gpm coming from re-circulation tank. The mixed 20 gpm flow was then introduced in the cell from bottom. The treated water from cell was allowed to split in to two streams. The first stream (1.0 gpm) was discharged to as treated water. The second stream 19 gpm was returned back to the re-circulation tank. The cell was operated at 30 amps at. 16 volts DC (480 watts). Totally 5,000 gallons of ground water was treated. The results are as follows:

TABLE XIII

| | CONC. PRIOR | CONC. AFTER |
|---|---|---|
| | TO TREATMENT | TREATMENT |
| CONTAMINANT | (ppb) | (ppb) |
| TPH (G) | 33,000 | ND |
| TPH (D) | 4,700 | ND |
| MTBE | 49,000 | ND |
| Benzene | 2,400 | ND |
| Toluene | 4,800 | ND |
| EthylBenzene | 1,200 | ND |
| Xylenes | 6,600 | ND |

In general the ground water contains calcium, magnesium, iron and many other interfering ions for conducting electrolysis. Particularly, calcium was found to deposit as calcium salt on the anode surface. This has presented a problem in the treatment process. Therefore following experiments were conducted to overcome the interference of these ions.

### EXAMPLE 11

Remediation of BTEX, MTBE and Petroleum derivatives in contaminated ground water was performed. The cell consist four sets of electrodes in one vessel (size 21″×19″×53″ H) described as above. The cell had 220 lbs. of GAC)

The re-circulation tank was charged with soft water to start with. Ground water was pumped from the underground well at a rate of 1.0 gallon per minute in to the filtration system equipped two stage filters 20 and 1.0 micron. The filtered water was introduced in to a low of 19 gpm coming from re-circulation tank via water softening system. The mixed 20 gpm flow was then introduced in the cell from bottom. The treated water from cell was allowed to split in to two streams. The first stream (1.0 gpm) was discharged to as treated water. The second stream 19 gpm was returned back to the re-circulation tank. The cell was operated at 30 amps at 16 volts DC (480 watts). Totally 5,000 gallons of ground water was treated. The results are as follows:

TABLE XIV

| | CONC. PRIOR | CONC. AFTER |
|---|---|---|
| | TO TREATMENT | TREATMENT |
| CONTAMINANT | (ppb) | (ppb) |
| MTBE | 33,000 | 740 |

### EXAMPLE 12

In this experiment two cells were used. One cell operated in the adsorption mode without current while the second cell was re-circulated with low calcium water with electrical current applied. The treatment on the second cell oxidized the organic contaminants adsorbed in the previous adsorption mode. Remediation of BTEX, MTBE and Petroleum derivatives in contaminated ground water was performed. These cells had four sets of electrodes in one vessel (size 21″×19″×53″ H) described as above. The cell had 220 lbs. of GAC)

Ground water was pumped from the underground well at a rate of 1.0 gallon per minute in to the filtration system equipped two stage filters 20 and 1.0 micron. The filtered water was introduced in to cell No 1 and discharged as treated water. The re-circulation tank was charged with low calcium water to start with. A 20 gpm flow was introduced in the cell No 2 from the bottom. The treated water from cell No 2 was allowed to return back to the re-circulation tank. The cell No 2 was operated at 30 amps at 16 volts DC (480 watts). A total of 10,000 gallons of ground water was treated. The results are as follows:

TABLE XV

| | CONC. PRIOR | CONC. AFTER |
|---|---|---|
| | TO TREATMENT | TREATMENT |
| CONTAMINANT | (ppb) | (ppb) |
| MTBE | 33,000 | 3,000 |

### EXAMPLE 13

In this example, instead of DC current AC current was employed in the electrolytic cell. Remediation of BTEX, MTBE and Petroleum derivatives in contaminated ground water was performed. The cell consist four sets of electrodes in one vessel (size 21″×19″×53″ H) described as above. The cell had 220 lbs. of GAC. Ground water was pumped from the underground well at a rate of 1.0 gallon per minute in to the filtration system equipped two stage filters 20 and 1.0 micron. The filtered water was introduced in to a low of 19 gpm coming from re-circulation tank via water softening system. The mixed 20 gpm flow was then introduced in the cell from bottom. The treated water from cell was allowed to split in to two streams. The first stream (1.0 gpm) was discharged to as treated water. The second stream 19 gpm was returned back to the re-circulation tank. The cell was operated between 34 to 45 amps at 18 to 22 volts AC (612-990 watts). In total, 5,000 gallons of ground water were treated. The results are as follows:

TABLE XVI

| | CONC. PRIOR | CONC. AFTER |
|---|---|---|
| | TO TREATMENT | TREATMENT |
| CONTAMINANT | (ppb) | (ppb) |
| MTBE | 33,000 | 3,000 |

### EXAMPLE 14

Treatment of dissolved organic contaminants and coliform in sewer water. The cell consisted of four sets of electrodes in one vessel (size 21″×19″×53″ H) as described as above. The cell had 220 lbs. of GAC.

Raw sewer water was pumped from the sanitary sewer at a rate of 30 gallons per minute into the prefiltration system equipped to remove material that either sank or floated and other large particulate matter and a two stage bag filter 20 and 1.0 microns. The pre-filtered water was then introduced directly into the top of the Cell at a flow rate of 30 gallons per minute. The water flowed through the Cell and the stream was then discharged (single pass at 30 gpm) as treated water. The cell was operated at 60 amps and 30 volts AC (1,800 watts). A total of 7,200 gallons of sewer water was treated. The results are as follows:

TABLE XVII

| | CONC. PRIOR | CONC. AFTER |
|---|---|---|
| | TO TREATMENT | TREATMENT |
| CONTAMINANT | (mg/l) | (mg/l) |
| TSS | 53 | 93 |
| COD | 110 | 61 |
| BOD | 52.5 | 34 |
| TOC | 39.5 | 24.8 |
| NO3 | <1.0 | <1.0 |
| Sur | 12 | 13.3 |
| Coliform Count | 6,400,000 | 6,000 |

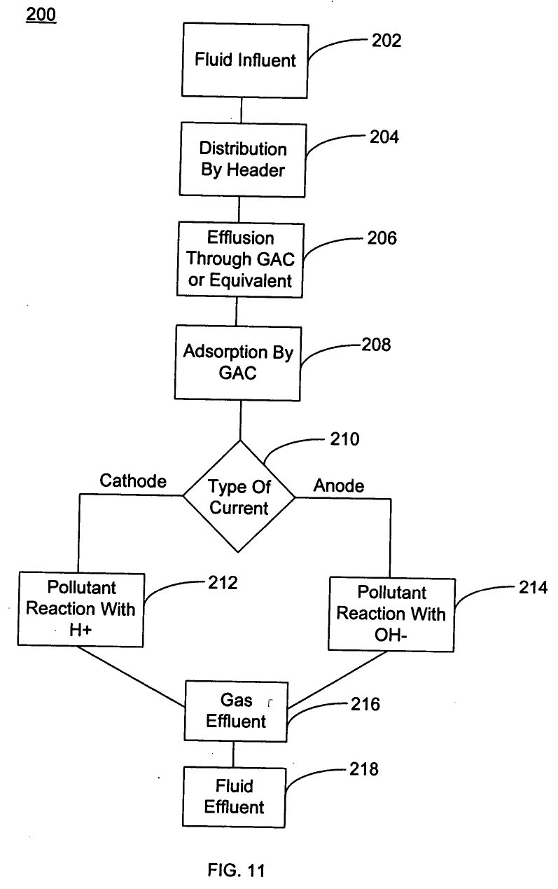

FIG. 11 shows a method of remediation of contaminated water as contemplated by the present invention. A source of contaminated water is collected and directed to a fluid influent port at step 202. Next, the influent is distributed to a cell in a stack by the header at step 204. The influent travels, or effluses, through the porous electrode, comprising GAC or its equivalent, at step 206. Step 208 anticipates the adsorption of contaminates by the porous electrode. Depending on the type of current, step 210, the porous electrode may be a cathode, an anode, or, in the case of alternating current, switching between an anode and a cathode at a rate depending on the hertz of the current. If the porous electrode is a cathode, step 212, the contaminate reacts with H⁺. If instead the porous electrode is an anode, step 214, the contaminate reacts with OH⁻. Treated effluent outgases reaction products at step 216 and passes to the next cell (or effluent port) at step 218.

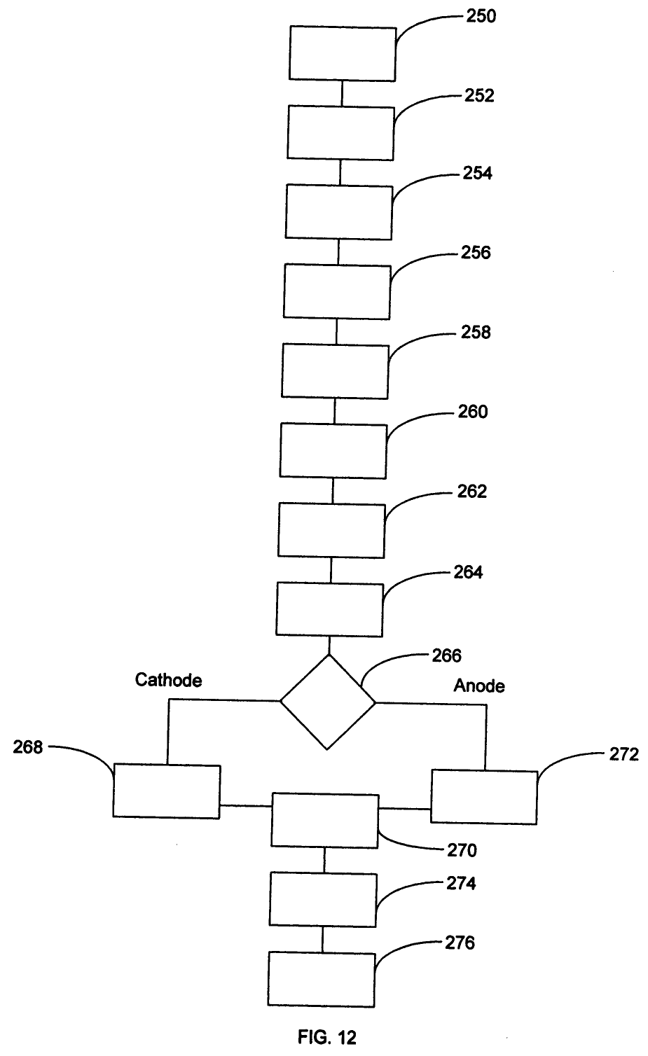

FIG. 12 shows a method of remediation of contaminated water as contemplated by the present invention. The method comprises:
step 250 obtaining a source of contaminated water,
step 252 distributing the water by a header into a stack of one or more cells,
step 254 separating the cells by electrically conductive particulate material,
step 256 supplying electric current to the particulate material,
step 258 effusing the water through the particulate material,
step 260 adsorbing water by the particulate material,
step 262 providing an electrically insulating ion permeable membrane,
step 264 separating electrodes within the particulate material by an electrically insulating ion permeable membrane,
step 266 supplying current to the electrodes so that one electrode is an anode and a second electrode is a cathode,
step 272 causing contaminates flowing past the anode to react with HO⁻ radicals producing gases,
step 268 causing contaminates flowing past the cathode to react with H⁺ radicals producing gases,
step 270 passing water to a next cell,
step 274 providing an exit for the gases, and
step 276 providing an effluent exit for treated water.

Although the present invention described herein and above are preferred embodiments, it is understood that after having read the above description, various alternatives will become apparent to those persons skilled in the art. For example, the porous electrode may be constructed from a more than one porous material. In an equally preferred embodiment, the porous electrode may include an activated carbon portion, and a portion constructed from some other porous conducting material such as a plated ceramic, conductive polymer foam or sponge, sintered metals, and the like. Similarly, different materials may be used for each porous electrode in an electrolytic cell having a plurality of porous electrodes.

We therefore wish our invention to be defined by the scope of the appended claims as broadly as the prior art will permit, and in view of the specification.

1. A stack of electrolytic cells comprising:
an inlet port for introduction of contaminated water to the electrolytic cells, and one or more reaction chambers each containing:
a) a porous, electrically conductive first electrode;
b) a second electrode; and
c) a porous insulator sleeve separating the porous electrode from the second electrode; and
means for supplying electric current to the first and second electrode.

2. The apparatus of claim 1 further comprising a header for distributing the water to the electrolytic cells.

3. The apparatus of claim 1 wherein at least one of the one or more reaction chambers is hydraulically sealed and includes an outlet port for exit of treated water from the one or more reaction chambers.

4. The apparatus of claim 3 wherein the contaminated water is introduced to the at least one of the one or more reaction chambers under pressure.

5. The apparatus of claim 1 wherein the porous, electrically conductive electrode comprises electrically conductive particles.

6. An electrolytic cell according to claim 5 wherein the particles are chosen from the group consisting of:
surface active carbon;
metal plated activated carbon;
silver;
gold;
ruthenium;
rhodium;
platinum;
sintered metal powders;
sintered conductive plastics;
sintered conductive polymers;
metal mesh; and
conductive, open-cell sponges.

7. A method of regenerating the electrically conductive particles of claim 6 comprising the steps of:
obtaining a source of non-contaminated water,
distributing the water by a header into the stack,
supplying electric current to the particles,
effusing the water through the particles, so that the particles are wetted by the water,
supplying current to the electrodes so that one electrode is an anode and a second electrode is a cathode, so that
contaminates adsorbed within the particles at the anode react with HO⁻ radicals producing gases, and contaminates adsorbed within the particles at the cathode react with H⁺ radicals producing gases,
providing an exit for the gases, and
providing an effluent exit for the water.

8. An electrolytic cell according to claim 1 wherein the second electrode is a plate chosen from the group consisting of:
stainless steel,
carbon,
gold,
platinum, and
titanium.

9. An electrolytic cell according to claim 1 wherein the second electrode is a plate comprising a non-conductive substrate plated with materials chosen from the group consisting of:
silver,
platinum,
gold, and
conductive plastics.

10. A stack of two or more electrolytic cells, adapted to reduce pollutants present in a stream of contaminated water, comprising:
a) an elongate water-tight housing comprising
(i) an elongate shell;
(ii) the shell enclosing the cells;
(iii) each cell in communication with the water;
(iv) a first plurality of interconnected first electrical connectors fitted at spaced apart points, each first connector communicating with each of the cells and which are adapted to be connected to a hot source of current;
(v) an end wall adapted to be water tight mounted on the open end of the shell;
(vi) a water inlet port positioned proximate a first end of the shell and adapted to provide liquid communication between the interior of the shell and a source of the contaminated water;
(vii) a water outlet port positioned proximate a second end of the shell and spaced apart from the water inlet port for discharging cell water treated therein; and
(viii) a second plurality of electrical connectors fitted at spaced apart points, each connector communicating with each of the cells and which are adapted to be connected to a neutral source of current;
b) a plurality of first electrodes in the form of a bed of electrically conductive particles each in electrical contact with each respective first electrical connector and which fills the interior of the housing between the plurality of first electrical connectors and a plurality of second electrodes each in electrical contact with each respective second electrical connector
c) each of the first electrodes and each of the second electrodes in liquid communication with the water; and
d) an electrically insulating ion permeable media in each cell which provides a space between the first electrode and the second electrode and whose pores provide passage through the media for water and ions treated in each cell to the liquid communication of the second electrode, whereby organic pollutants in a stream of polluted water which is passed through each cell while it is connected to a source of electric current are adsorbed onto the surface of the particles from the second electrode and destructively oxidized or reduced while adsorbed thereon and treated water then passes through the insulating wall and the liquid communication means of the second electrode and is then discharged from the shell through the water outlet port.

11. An electrolytic cell according to claim 10 wherein the particles are chosen from the group consisting of:
surface active carbon;
metal plated activated carbon;
silver;
gold;
ruthenium;
rhodium;
platinum;
sintered metal powders;
sintered conductive plastics;
metal mesh; and
conductive, open-cell sponges.

12. A method for remediation of contaminated water comprising:
obtaining a source of contaminated water,
distributing the water by a header into a stack of one or more cells,
separating the cells by, and filling space within the cells with, electrically conductive particulate material,
supplying electric current to the particulate material,
effusing the water through the particulate material, so that the water is adsorbed by the particulate material,
separating electrodes within the particulate material by an electrically insulating ion permeable membrane,
supplying current to the electrodes so that one electrode is an anode and a second electrode is a cathode, so that
contaminates flowing past the anode react with HO⁻ radicals producing gases, and contaminates flowing past the cathode react with H⁺ radicals producing gases,
providing an exit for the gases, and
providing an effluent exit for treated water.

13. The method of claim 12 wherein the current is direct current.

14. The method of claim 12 wherein the current is alternating current.

15. The method of claim 12 further comprising the steps of:
pre-treating the water and
post-treating the water.

16. The method of claim 15 wherein the pre-treating and post-treating of the water are processes chosen from the group consisting of:
pH adjusting,
controlling conductivity,
water softing,
introducing oxidizing agents,
introducing reducing agents, and
exposing to ultraviolet light.

17. The method of claim 12 wherein the electrically conductive particulate material are particles chosen from the group consisting of:
surface active carbon;
metal plated activated carbon;
silver;
gold;
ruthenium;
rhodium;
platinum;
sintered metal powders;
sintered conductive plastics;
sintered conductive polymers;
metal mesh; and
conductive, open-cell sponges.

18. A method of remediation of contaminated water comprising:
obtaining a source of contaminated water,
distributing the water by a header into a stack of one or more cells,
separating the cells by electrically conductive particulate material,
supplying electric current to the particulate material,
effusing the water through the particulate material,
adsorbing water by the particulate material,
providing an electrically insulating ion permeable membrane,
separating electrodes within the particulate material by an electrically insulating ion permeable membrane,
supplying current to the electrodes so that one electrode is an anode and a second electrode is a cathode,
causing contaminates flowing past the anode to react with HO⁻ radicals producing gases,
causing contaminates flowing past the cathode to react with H⁺ radicals producing gases, passing water to a next cell,
providing an exit for the gases, and
providing an effluent exit for treated water.

19. The method of claim 18 wherein the current is direct current.

20. The method of claim 18 wherein the current is alternating current.

21. The method of claim 18 wherein the electrically conductive particulate material are particles are chosen from the group consisting of:
surface active carbon;
metal plated activated carbon;
silver;
gold;
ruthenium;
rhodium;
platinum;
sintered metal powders;
sintered conductive plastics;
sintered conductive polymers;
metal mesh; and
conductive, open-cell sponges.
